(19) United States
(12) Patent Application Publication
(10) Pub. No.: US 2017/0190341 A1
(43) Pub. Date: Jul. 6, 2017

(54) SHOPPING CART WITH REUSABLE TRAYS FOR IN-SITU SCANNING OF ITEMS THEREIN

(71) Applicant: Akiko Kobayashi, Carlsbad, CA (US)

(72) Inventor: Akiko Kobayashi, Carlsbad, CA (US)

(21) Appl. No.: 14/985,938

(22) Filed: Dec. 31, 2015

(51) Int. Cl. B62B 3/02; G06K 7/10; G06Q 90/00

(52) U.S. Cl. CPC B62B 3/02; G06Q 90/00; G06K 7/10861

(57) ABSTRACT

Disclosed is a shopping cart comprising a cart body comprising one or more shelves and one or more trays configured to be detachably attachable to the one or more shelves, respectively, and reusable. The one or more trays are configured to be owned by a user, be transported by the user to a store, be attached to the one or more shelves, respectively, by the user, be loaded with items picked up by the user in the store go through in-situ scanning of the items therein for checkout, be detached from the one or more shelves, respectively, and be transported with the purchased items therein to the user's home or a destination, wherein the in-situ scanning is done by using a scanner to scan codes on the items while they are in the one or more trays.

### BACKGROUND

Even with the advent of online shopping, people have needs and likes to physically go for shopping at supermarkets, warehouse stores, department stores and other retail stores, to buy groceries, toiletries, clothing, stationery, electronics, appliances, etc. to actually take a look at, touch and feel a wide variety of displayed items to select from. Large basket-like shopping carts are generally provided at the store to enable shoppers to put the selected items therein as they traverse and pick up multiple items in the store. One or more checkout counters are provided to scan and/or weigh the items to determine the total price to be paid. Shoppers have to stand in line, and checkout lines are typically long. Some stores provide self-checkout lanes. However, there are some people who do not like such do-it-yourself checkout, because he/she is not used to it or it takes longer than the conventional checkout handled by an experienced, fast cashier working for the store.

At the checkout counter, the items are transferred to a conveyor belt, which transports the items toward a scanner built in the checkout counter. The items typically have codes printed thereon. Handheld scanners are occasionally used for heavy items, which are kept in the cart. The codes are scanned and registered to give the total price, which the shopper pays, while or thereafter the items after scanning acre being put in plastic or paper bags. Reusable bags are more and more common nowadays, replacing disposable plastic or paper bags, due to environmental concerns. Reusable bags are typically made of woven synthetic fibers, flexible plastics, polymers and the like for durability. After paying, the shopper takes the bags, leaves the store, transfers the bags onto his/her car, and returns the cart to a collection station.

Shopping cans in general are extremely dirty and filthy. Some reports from environmental scientists have shown that coliform bacteria (common in soil on vegetation and in the feces of animals) were present in high amounts on more than 70% of carts tested, and E. coli was present on almost 50% of them. In fact, the researchers pointed out that the bacteria levels on the carts were greater than what is typically found in public restrooms and other public places. According to the study, the potential causes of contamination include contact with contaminated raw foods such as those found in a supermarket, bird or other animal feces (which may contaminate the carts while they sit in the parking lot), or contact with feces-contaminated hands (or other body parts) of previous cart users or children in diapers.

The same story goes true with checkout conveyor belts at supermarkets. It is known that they are, actually a breeding ground for unwanted bacteria. Some studies show that yeast, mold, staph and coliforms are living and growing on these belts. A recent university research found bacterial contamination on 100 percent of belts tested.

In spite of these problems, shopping has long been based on using conventional carts, and conventional checkout systems. This document describes a new concept of shopping carts that can prevent purchased items front contacting dirt and filth, commonly present on conventional shopping carts and conveyor belts, and can eliminate the need for conventional checkout systems.

### BRIEF DESCRIPTION OF THE DRAWINGS

FIG. 1 illustrates a side view of an example of a shopping cart according to an embodiment.

FIG. 2 illustrates a top view of the shopping cart, showing an example configuration of the trays and the shelves while the trays are detachably attached to the shelves, respectively, wherein relative placements in the horizontal direction are depicted correspondingly to the assembly illustrated in FIG. 1, but otherwise-overlapped placements in the vertical direction are shifted into three layers for the sake of better viewing.

FIG. 3 illustrates a top view of an example configuration of the empty trays when stacked.

FIG. 4 illustrates a top view of an example configuration of the loaded trays, which are arranged to fit in a trunk of a car.

FIG. 5 illustrates a side view of an example configuration, wherein the middle tray, i.e., the smallest tray, is configured to fit in a shopping basket.

FIG. 6 illustrates a side view of an example configuration of in-situ scanning of the items in the trays by using a handheld scanner.

FIG. 7 illustrates a side view of another example configuration of in-situ scanning of the items in the trays by using a handheld scanner.

FIG. 8 illustrates a top view of the shopping cart, showing another example configuration of the trays and the shelves while the trays are detachably attached to the shelves, respectively, wherein relative placements in the horizontal direction are depicted correspondingly to the assembly illustrated in FIG. 1, but otherwise-overlapped placements in the vertical direction are shifted into three layers for the sake of better viewing.

FIG. 9 illustrates a side view of two cart bodies nesting for storage.

FIG. 10 illustrates a side view of two can bodies nesting for storage.

FIG. 11 illustrates an example configuration of the empty trays when stacked.

FIG. 12 illustrates a top view of an example configuration of the loaded trays, which are arranged to fit in a trunk of a cart.

FIG. 13 illustrates an example of an attaching mechanism.

FIGS. 14-16 illustrate another example of an attaching mechanism.

FIGS. 17-21 illustrate a side view of five example configurations of the shelves and trays, respectively, according to embodiments.

FIGS. 22 and 23 illustrate example configurations of a shelf and a tray detachably attached thereto, wherein the overall horizontal shape of the shelf and that of the corresponding tray are substantially different.

FIG. 24 illustrates a side view of an example configuration of in-situ scanning of the items in the trays by using a tunnel-shaped scanner.

### DETAILED DESCRIPTION

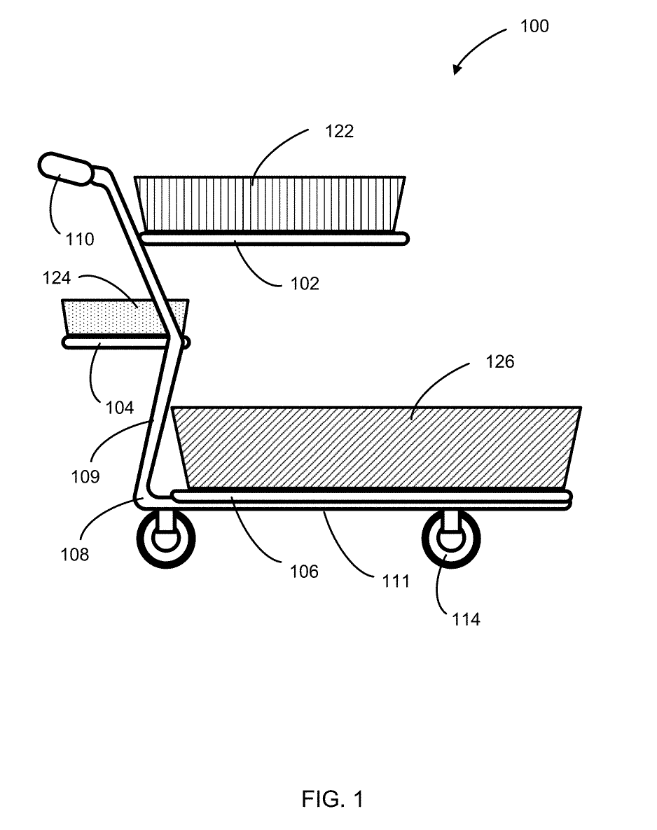

In view of the problems associated with the conventional shopping cans and checkout systems at retail stores, shopping carts according to the present invention are configured to allow for in-situ scanning of items in reusable trays, thereby eliminating the need for a conveyor belt at checkout and also the possibility for items to contact bacteria and other filth generally present on surfaces of a conventional shopping cart and a conventional conveyor belt. The present shopping cart comprises a cart body and one or more reusable trays detachably attached thereto. That is, each of the one or more trays is configured to be attached to and detached from the cart body by a user, and is reusable. The cart body includes one or more shelves, a frame, and multiple wheels, wherein the one or more shelves are configured to hold the one or more trays, respectively, when the trays are attached thereto. FIG. 1 illustrates a side view of an example of a shopping cart according to an embodiment. It should be noted that the drawings in this document are not to scale. In the example illustrated in FIG. 1, three shelves 102, 104 and 106 are coupled to a frame 108. The frame 108 includes a handle 110 at the top portion for a shopper, i.e., a user, to hold to steer and move the shopping cart 100. The frame 108 further includes a vertical section 109 and a horizontal bottom section 111, which is formed to have a large area and to be substantially horizontal to the ground, and is coupled to at least three wheels 114. The vertical section 109 is formed substantially vertical to the horizontal bottom section 111, wherein the relative angle therebetween may be approximately 90° or in its proximity, and the vertical shape can be straight, bent or other shape, as long as the vertical section 109 and the horizontal section 111 together form a stable frame 108. The top portion of the vertical section 109 of the frame 108 is configured to have the handle 110. The shelves 102, 104 and 106 are coupled to the frame 108 of the cart body and positioned to be substantially horizontal to the ground, and hence to the horizontal bottom section 111 of the frame 108. The horizontal bottom section 111 may be configured to couple to the bottom self 106, in that: the horizontal bottom section 111 itself may be modified or configured for use as the bottom shelf 106; alternatively, the bottom shelf 106 may be attached or integrated with the horizontal bottom section 111; further alternatively, the bottom shelf 106 may be positioned and mechanically held slightly above the horizontal bottom section 111 with small vertical spacing in between. The shopping cart 100 in this example includes three trays 122, 124 and 126, detachably attached to the shelves 102, 104 and 106 of the cart body, respectively. That is, the, trays 122, 124 and 126 are configured to be, attached to and detached from the corresponding shelves 102, 104 and 106, respectively, by a user. The shelves 102, 104 and 106 are configured to be substantially horizontal so as to hold the trays 122, 124 and 126, respectively. The number of trays and the number of corresponding shelves can be one or more. The frame 108 and the shelves 102, 104 and 106 may be made of plastic, metal, other hard and sturdy material, or a combination thereof. The trays 122, 124 and 126 may be made of a recyclable, light-weight and fairly durable material, such as plastic, cardboard, molded pulp, fiber glass, etc. Known examples of such trays include: an MM tray (managed mail tray) used for containing and transporting letter mails to or between post offices; a tray used for containing and transporting personal items and carry-on bags through an X-ray system at a security checkpoint in an airport.

The trays 102, 104 and 106 are configured to be reusable according to an embodiment, just like commonly used reusable shopping bags. Once a user purchases the trays, these trays are property of the user and can be kept in storage at home or in a trunk of the user's car, for example. The trays can be made of a washable material, so that the user can clean the trays using soap, detergent or other household cleaning product as he/she wishes. When the user goes for shopping, he/she brings the trays to the store, the trays being carried in the trunk of his/her car, for example. Corresponding cart bodies are provided in the premise or proximity of the store, and the user takes up one of them to attach the trays onto the respective shelves of the cart body. Depending on the expected amount of shopping, the user can brings one or more trays, which can be attached to the respective one or more shelves. For example, FIG. 1 illustrates all three trays are attached to the respective three shelves; however, the user can bring and use at least one tray by attaching the at least one tray to the corresponding at least one shelf while keeping the other shelf or shelves open. The trays are intended to stay with the cart body throughout the shopping, including the checkout, until the trays loaded with purchased items are transferred to the user's car. After transferring the trays loaded with purchased items to the user's car, the user can return the cart body to a collection station of the store. Thus, the items picked up by the user in the store stay in the trays, and are scanned and registered at the checkout counter by a handheld scanner or the like. The user does riot have to transfer the items from the trays onto a conveyer belt at the checkout; nor does the user or a worker have to transfer the checked-out items from the conveyor belt back into the trays. Therefore, the conventional conveyor system at the checkout can be eliminated. By using the reusable trays and the correspondingly designed cart body, the items that the user picked up and put in the trays do not contact generally unhygienic conventional shopping carts conveyer belts. Each of the items can stay in the tray from the time the user put it in the tray in the store, and during the entire shopping, the checkout and the transport to home or to a destination where the item is finally unloaded from the tray for use or for storage at home or at the destination.

The dimensions and the shape of each tray and those of the corresponding shelf are configured to generally fit with each other so that the tray can be stably held on the shelf. designs, including dimensions, overall shapes and materials, of the trays, and the corresponding be customized according to the type of items sold in each store. For example, for warehouse-type stores such as COSTCO® and Sam's Club®, where generally large, bulky items are sold, the trays and the shelves can be made large compared to those for use in grocery stores. In another example, for home improvement retailers for tools, appliances and other products such as Home Depot® and Lewe's®, where generally heavy and hard items are sold, the trays and the shelves can be made of a strong, durable material compared to those for use in grocery stores. Just like commonly used reusable bags, the trays that are designed per the store specifications may include the store logo, trademark, patterns and colors, or other visual designs indicating the brand and other characteristics of the store, and be sold in the store to be used by frequent shoppers at the store.

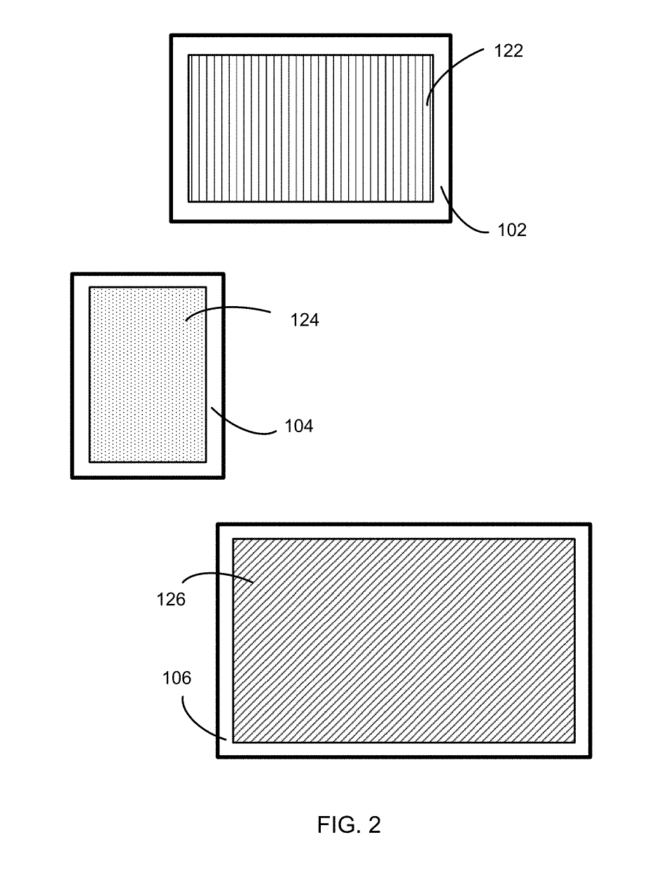

FIG. 2 illustrates a top vie of the shopping cart 100, showing an example configuration of the trays and the shelves while the trays are attached to the shelves, respectively, wherein relative placements in the horizontal direction are depicted correspondingly to the assembly illustrated in FIG. 1, but otherwise-overlapped placements in the vertical direction are shifted into three layers for the sake of better viewing. The bottom surfaces of the top tray 122, the middle tray 124 and the bottom tray 126 are illustrated to be placed on the top shelf 102, the middle shelf 104 and the bottom shelf 106, respectively. In this example, each of the shelves has a generally rectangular horizontal shape, which can be planar, meshed or in any pattern. Alternatively, each shelf may be configured to have four connecting elongated plates or rods with the center portion open so as to hold four edge portions of the bottom surface of the corresponding tray. As can be seen from FIGS. 1 and 2, with respect to the vertical section 109 of the frame 108, the top and bottom shelves 102 and 106 are placed on one side facing toward the direction of movement of the cart 100, and the middle shelf 104 is placed on the opposite side. The middle shelf 104 is positioned lower than the top shelf 102 and higher than the bottom shelf 106. Thus, when viewed along the vertical direction, the overlap between the top tray's bottom surface area and the middle tray's top open area is minimal or none; the overlap between the bottom tray's top open area and the middle tray's bottom surface area is minimal or none; and sufficiently large vertical spacing is provided between the top shelf 102 and the bottom tray 126. In the present example, the horizontal dimension along the direction of movement, i.e. the length, of the bottom shelf 106, hence the bottom tray 126, is the largest; the length of the middle shelf 104, hence the middle tray 124, is the smallest; and the length of the top shelf 102, hence the top tray 122, is between the largest and the smallest. Correspondingly, as illustrated in FIG. 1, the heights or depths of the trays may be configured such that: the height of the bottom tray 126 is the largest; the height of the middle tray 124 is the smallest; and the height of the top tray 122 is between the largest and the smallest. By configuring the dimensions of the trays and shelves as above, shoppers will be naturally motivated to put relatively heavy and bulky items in the bottom tray 126 and relatively light and small items in the middle tray 124 for better stability and balance of the shopping cart 100 when loaded.

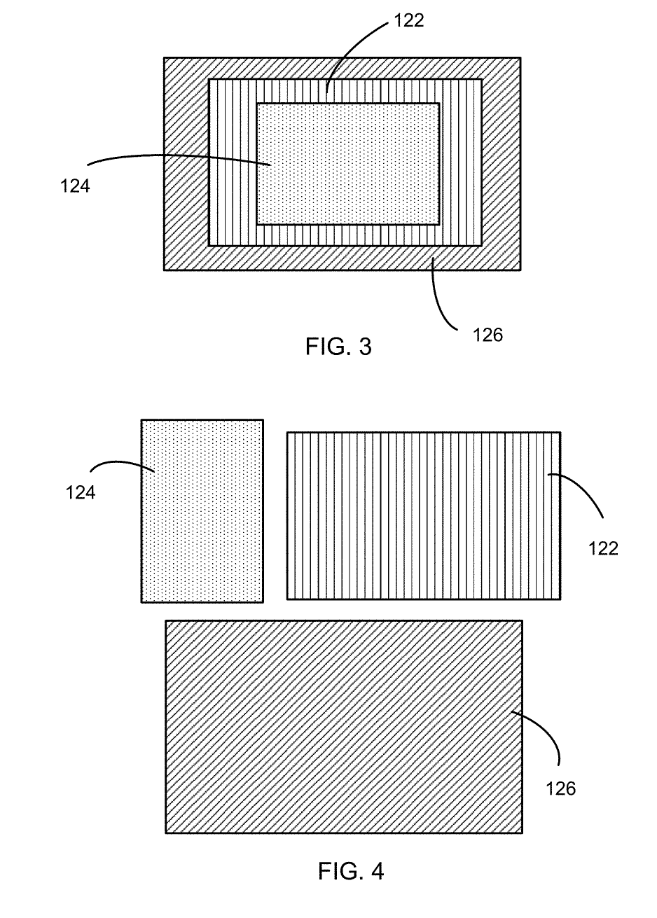

The dimensions of the trays illustrated in FIG. 2 may be further configured so that the trays are stackable to save space when they are not used or in storage at home or in a trunk of a car, for example. FIG. 3 illustrates a top view of all example configuration of the empty trays when stacked. In this example, the horizontal dimension along the direction orthogonal to the direction of movement, i.e. the width, of the top tray 122 is configured to be smaller than that of the bottom tray 126, so that these two trays can be stacked with the top tray 122 on top of and in the bottom tray 126 with the lengths substantially aligned with each other and the widths substantially aligned with each other. Further in this example, the width of the middle tray 124 is configured to be smaller than the length of the top tray 122, and the length of the middle tray 124 is configured to be smaller than the width of the top tray 122. As a result, the middle tray 124 can be stacked on top of and in the top tray 122, it is often the case for reusable shopping bags that a user forgets to take them to a store from home or decides unexpectedly on the way back from another place to stop by a store for shopping without carrying them. By keeping the stacked trays in a trunk of a car, as suggested in FIG. 3, the chance for a user to enter a store without having the reusable trays becomes minimal or none.

The dimensions of the trays illustrated in FIGS. 2 and 3 may be further configured so that the trays, each loaded with items, can fit in a trunk of a ear. FIG. 4 illustrates a top view of an example configuration of the loaded trays, which are arranged to fit in a trunk of a car. The largest tray, i.e., the bottom tray 126, will naturally be loaded with heavy, bulky items; thus, the user would prefer to place it close to the opening of the trunk. Accordingly, the dimensions of the bottom tray 126 can be configured to fit in the part of the trunk close the opening; and the dimensions of the top tray 122 and the middle tray 124 can be configured to fit generally side-by-side in the deep part of the trunk.

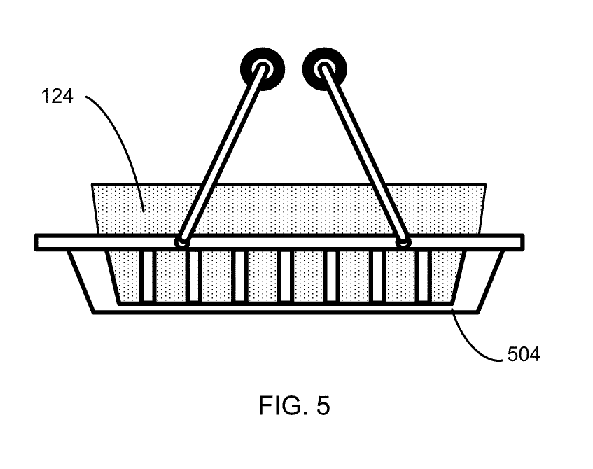

The dimensions of one of the trays may be further configured so that it can fit in a Shopping basket as well. FIG. 5 illustrates a side view of an example configuration, wherein the middle tray 124, i.e., the smallest tray, is configured to fit in a shopping basket 504. The height of the tray 124 may be configured to be larger than the height of the basket 504, so that the tray 124 can be easily put in and taken out from the basket 504 by a user.

As mentioned earlier, the trays are intended to stay with the cart body throughout the shopping, including the checkout, until the trays loaded with purchased items are transferred to the user's car. The items picked up by the user in the store stay in the trays, and are scanned and registered at the checkout counter by a handheld scanner or the like. To enable the use of a handheld scanner, the dimensions, shapes and positions of the shelves and the corresponding trays are configured so that the items in each tray can be scanned without ergonomic difficulty, in the example illustrated in FIGS. 1 and 2, the top and bottom shelves 102 and 106 are placed on one side, with respect to the vertical section 109 of the frame 108, facing toward the direction of movement of the shopping cart 100; and the middle shelf 104 is placed on the opposite side. Thus, when viewed along the vertical direction, the overlap between the top tray's bottom surface area and the middle tray's top open area is minimal or none; the overlap between the bottom tray's top open area and the middle tray's bottom surface area is minimal or none; and sufficiently large vertical spacing is provided between the top shelf 102 and the bottom tray 126. In the present example, the horizontal dimension along the direction of movement, i.e., the length, of the bottom shelf 106, hence the bottom tray 126, is the largest; the length of the middle shelf 104, hence the middle tray 124, is the smallest; and the length of the top shelf 102, hence the top tray 122, is between the largest and the smallest. A configuration such as above allows for easy in-situ scanning of the items in the trays, without the need for taking out the items from the trays. The scanning can be carried out by a worker of the store or the shopper himself/herself, in either case, the maneuver of a handheld scanner should be ergonomically easy so as not to cause discomfort or strain to a hand or other body part of the person scanning the items. In general, lifting a heavy, bulky item from a cart to place it on a conveyor belt for scanning, as well as putting the item back to a shopping bag or to the cart, is considered to be physically more demanding than the in-situ scanning using a handheld scanner.

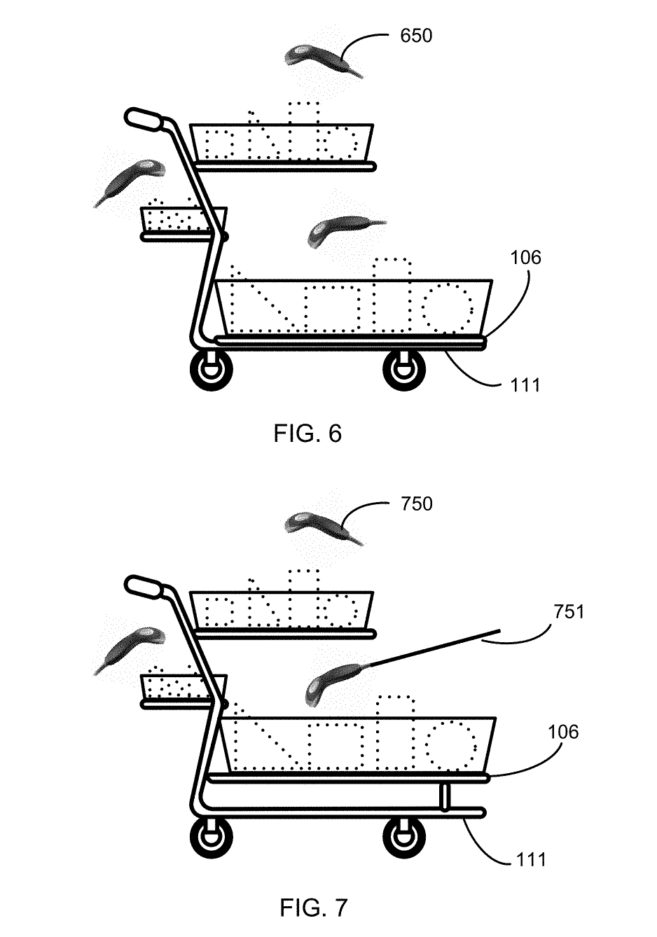

FIG. 6 illustrates a side view of an example configuration of in-situ scanning of the items in the trays by using a handheld scanner. The items the user picked up and put in the trays are indicated by dotted lines in this figure. In this example, the bottom shelf 106 is integrated or attached directly to the horizontal bottom section 111 of the frame 108 coupled to the wheels. Thus, the top and bottom shelves are configured to have the sufficiently large vertical spacing therebetween. The configuration in FIG. 6 allows for the scanning person to easily move a handheld scanner 650 for scanning the items in each of the trays.

FIG. 7 illustrates a side view of another example configuration of in-situ scanning of the items in the trays by using a handheld scanner. The items the user picked up and put in the trays are indicated by dotted lines in this figure. In this example, the bottom shelf 106 is placed slightly above from the horizontal bottom section 111 of the frame 108 coupled to the wheels. The spacing above the bottom tray and below the top shelf is sufficiently large in this example, but may or may not be enough for the scanning person to maneuver a handheld scanner 750 without feeling discomfort or strain in his/her hand, back or other part of his/her body. The problem can be resolved by using a handheld scanner having an extension 751, for example, to reduce the need for bending or moving of his/her hand, back or other part of his/her body.

FIG. 8 illustrates a top view of the shopping cart 100, showing another example configuration of the trays and the shelves while the trays are detachably attached to the shelves, respectively, wherein relative placements in the horizontal direction are depicted correspondingly to the assembly illustrated in FIG. 1, but otherwise-overlapped placements in the vertical direction are shifted into three layers for the sake of better viewing. The bottom surfaces of the top tray 122, the middle tray 124 and the bottom tray 126 are illustrated to be placed on the top shelf 102, the middle shelf 104 and the bottom shelf 106, respectively. Similar to FIGS. 1 and 2, in FIG. 8, the top and bottom shelves 102 and 106 are placed on one side, with respect to the vertical section 109 of the frame 108, facing toward the direction of movement of the shopping cart 100; and the middle shelf 104 is placed on the opposite side. Thus, when viewed along the vertical direction, the overlap between the top tray's bottom surface area and the middle tray's top open area is minimal or none; the overlap between the bottom tray's top open area and the middle tray's bottom surface area is minimal or none; and sufficiently large vertical spacing is provided between the top shelf 102 and the bottom tray 126. In the present example, the horizontal dimension along the direction of movement, i.e., the length, of the bottom shelf 106, hence the bottom tray 126, is the largest; the length of the middle shelf 104, hence the middle tray 124, is the smallest; and the length of the top shelf 102, hence the top tray 122, is between the largest and the smallest Correspondingly, as illustrated in FIG. 1, the heights or depths of the trays may be configured such that: the height of the bottom tray 126 is the largest; the height of the middle tray 124 is the smallest; and the height of the top tray 122 is between the largest and the smallest. By configuring the dimensions of the trays and shelves as above, shoppers will be naturally motivated to put relatively heavy and bulky items in the bottom tray 126 and relatively light and small items in the middle tray 124 for better stability and balance of the shopping cart 100 when loaded.

The example configuration in FIG. 8 shows that the horizontal shapes of the top shelf 102, the top tray 122, the bottom shelf 106 and the bottom tray 126 are different from those illustrated in FIG. 2. Each of these four elements is horizontally shaped to be generally tapered toward the direction of movement, having a front width narrower than a rear width. Furthermore, each of the top shelf 102 and the bottom shelf 106 is configured to have a horizontal shape of a generally U-shaped frame for holding three edge portions of the bottom of the corresponding tray, the generally U-shaped frame tapered toward the direction of movement and having an opening at the rear side with respect to the direction of movement. The top view or the inner shape of each of the top shelf 102 and the bottom shelf 106 is indicated by dashed line in FIG. 8.

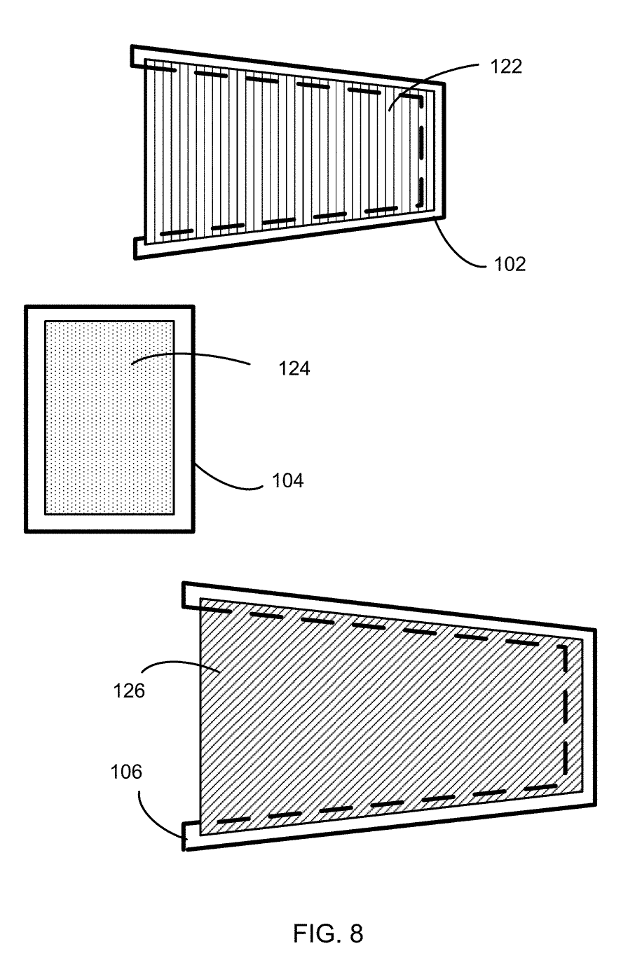

Nowadays, shopping carts are typically designed to nest within each other in a line to facilitate collecting and also to save on storage space. The so-called “telescope” cart is designed so that the rear of the cart swings forward when another cart is shoved into it from behind, hence providing the nesting feature. In the case where the present shopping cart with reusable trays axe employed, the user returns the cart body to a collection station of the store after transferring the trays loaded with purchased items to the user's car. FIG. 9 illustrates a side view of two cart bodies nesting for storage. In this case, as illustrated in FIG. 2, each of the shelves has a generally rectangular horizontal shape. The top view of the two top shelves 102 is illustrated above the side view of the two nested cart bodies in FIG. 9, with dash-dot lines indicating the corresponding edges. Similarly, the top view of the two bottom shelves 106 is illustrated below the side view of the two nested cart bodies, with dash-dot lines indicating the corresponding edges. In this case, the nesting distance, i.e., the distance that can be saved by the nesting, is about or less than the length of the middle shelf 104.

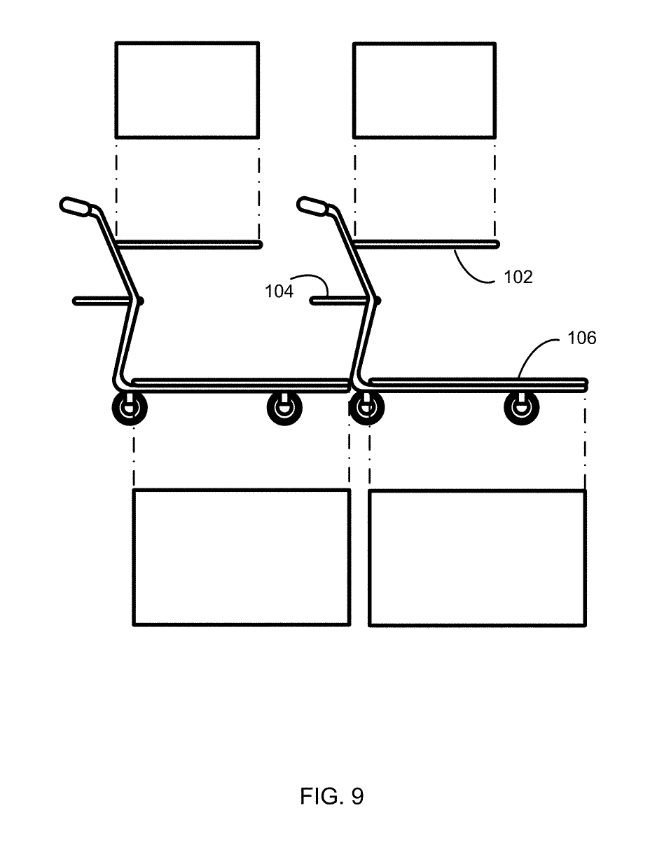

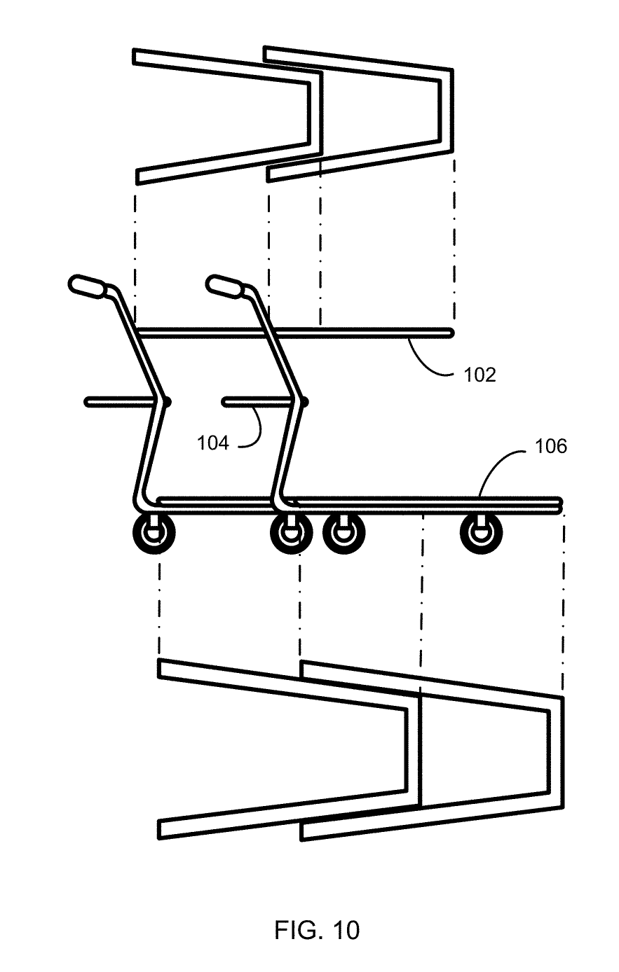

FIG. 10 illustrates a side view of two cart bodies nesting for storage. In this case, as illustrated in FIG. 8, each of the top shelf 102 and the bottom shelf 106 is horizontally shaped to be generally tapered toward the direction of movement, having a front width narrower than a rear width; and each of the top shelf 102 and the bottom shelf 106 is configured to have a horizontal shape of a generally U-shaped frame for holding the bottom of the corresponding tray. The top view of the two top shelves 102 is illustrated above the side view of the two nested cart bodies in FIG. 10, with dash-dot lines indicating the corresponding edges. Similarly, the top view of the two bottom shelves 106 is illustrated below the side view of the two nested cart bodies, with dash-dot lines indicating the corresponding edges. In this case, the nesting distance, i.e., the distance that can be saved by the nesting, is about the length of the front portion of the bottom shelf 104, the portion being inserted through the opening of the U-shape of the other bottom shelf 104 in front of it.

As illustrated in FIG. 10, the generally tapered U-shaped top and bottom shelves allow for space-saving nesting of the cart bodies owing to the rear opening of the U-shaped shelves, which is tapered along the direction of movement of the cart body. Thus, one of ordinary skill in the art would understand that the horizontal bottom section 111, which is coupled to the bottom shelf 106, should be correspondingly configured to have a rear opening. Since the nesting concerns only the cart bodies, the shapes of the trays are not limited to those with the tapered sides as illustrated in FIG. 8; the trays can have any horizontal shapes, as long as they are configured to be attached to and detached from respective shelves, and to enable easy in-situ scanning of items in the trays when attached to the respective shelves.

The dimensions of the trays illustrated in FIG. 8 may be further configured so that the trays are stackable to save space when they are not used or in storage at home or in a trunk of a car, for example. FIG. 11 illustrates an example configuration of the empty trays when stacked. In this example, the four side dimensions, i.e., the front width, the rear width and the two side lengths along the tapered direction of the bottom tray 126 are larger than the four side dimensions of the top tray 122, respectively, so that the top tray 122 can be stacked on top of and in the bottom tray 126, with the four edges of the top tray 122 substantially aligned with the four edges of the bottom tray 126, respectively. Further in this example, the width of the middle tray 124 is configured to be smaller than the length of the top tray 122 and the length of the middle tray 124 is configured to be smaller than the rear width of the top tray 122, so that the middle tray 124 can be stacked on top of and in the top tray 122. The dimensions of the middle tray 124 may be further configured so that it can fit in a shopping basket, as illustrated in FIG. 5.

The dimensions of the trays illustrated in FIGS. 8 and 11 may be further configured so that the trays, each loaded with items, can fit in a trunk of a car. FIG. 12 illustrates a top view of an example configuration of the loaded trays, which are arranged to fit in a trunk of a car. The largest tray, i.e., the bottom tray 126, will naturally be loaded with heavy, bulky items; thus, the user would prefer to place it close to the opening of the trunk Accordingly, the dimensions of the bottom tray 126 can be configured to fit in the part of the trunk close to the opening; and the dimensions of the top tray 122 and the middle tray 124 can be configured to fit generally side-by-side in the deep part of the trunk.

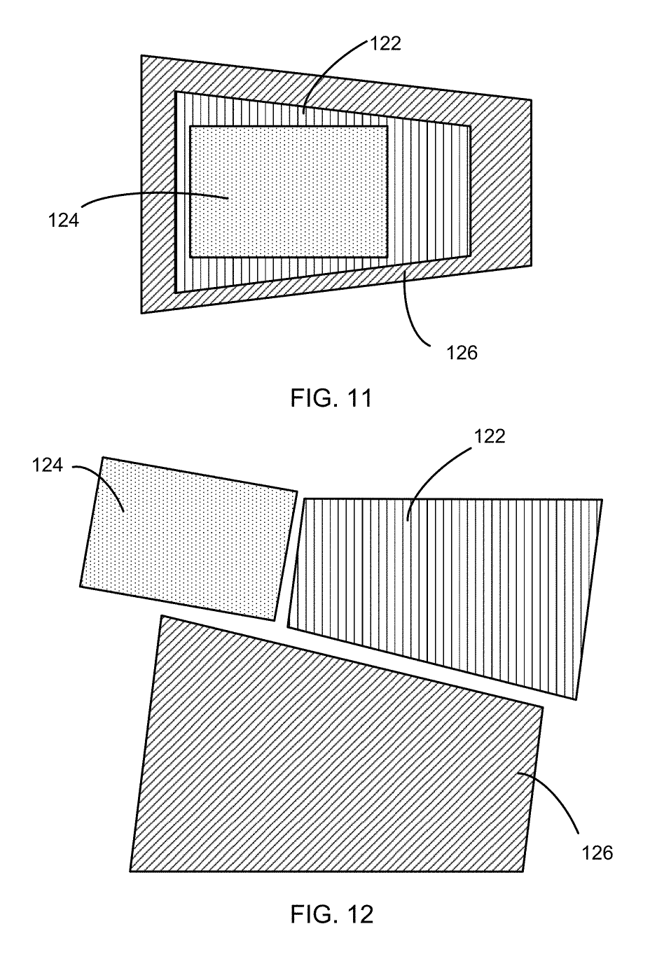

As mentioned earlier, the trays 122, 124 and 126 are configured to, be detachably attached to the corresponding shelves 102, 104 and 106, respectively, of the cart body. Any conventional detachably attaching mechanism known to one of ordinary skill in the art can be utilized. For example, each shelf may be configured to have a basket-like shape with four raised side sections, wherein the heights of the side sections are configured to be lower than the height of the corresponding tray so that the tray can easily fit in the basket-like shape. Alternatively or additionally, hooks, latches and other fastening means can be used. FIG. 13 illustrates another example of an attaching mechanism, wherein a band 1304 coupled to the cart body is used to hold the top tray 122 on the top shelf 102. The band 1304 can be made of plastic, metal, elastic, epoxy or other durable material. Only the band 1304 for holding the top tray 122 on the top shelf 102 is illustrated in this example; however, the middle and bottom trays can also be detachably attached to and held on the corresponding shelves by using similarly configured bands, respectively.

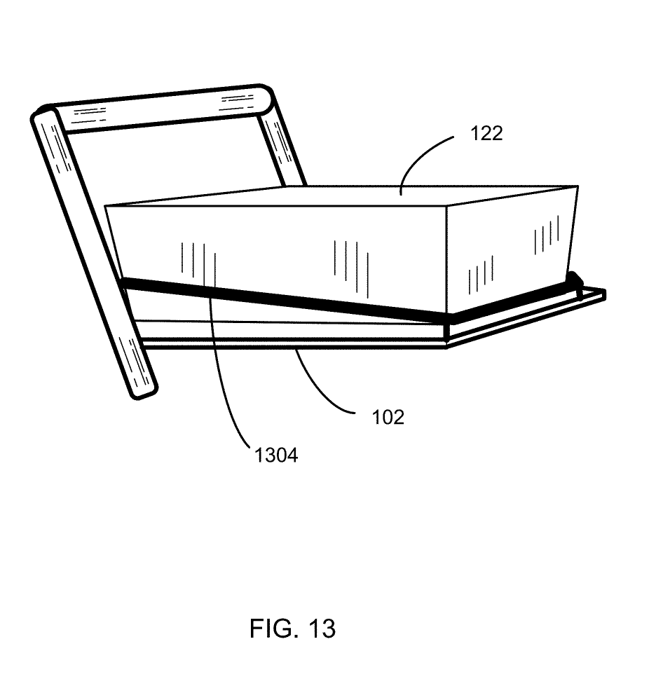

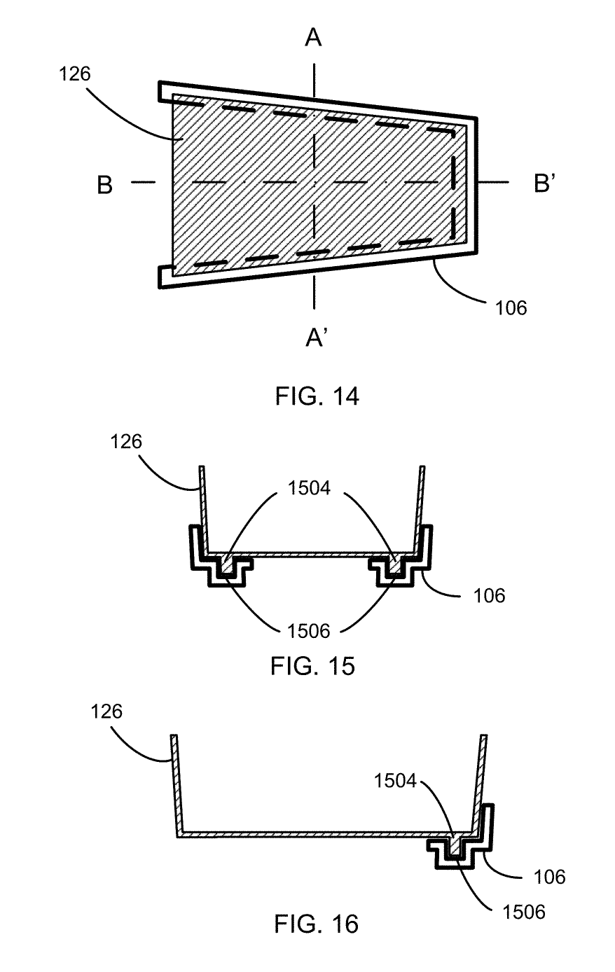

FIGS. 14-16 illustrate another example of an attaching mechanism, wherein a structure similar to a so-called “tongue-and-groove engagement” is used to hold the bottom tray 126 on the bottom shelf 106. FIG. 14 illustrates the top view of an example configuration of the bottom shelf 106 and the bottom tray 126 that are detachably attached to each other via the tongue-and-groove engagement. FIG. 15 illustrates a cross-sectional view of this example configuration on the vertical plane indicated by A-A′ in FIG. 14; and FIG. 16 illustrates a cross-sectional view of this example configuration on the plane indicated by B-B′, which is orthogonal to the plane indicated by A-A′, in FIG. 14. The tongue-and-groove engagement mechanism for holding only the bottom tray 126 on the bottom shelf 106 is illustrated in this example; however, the middle and top trays can also be detachably attached to and held on the corresponding shelves by using similarly configured tongue-and-groove engagements, respectively, in this example, a tongue 1504, which is a protrusion, is formed along the three edge portions, corresponding to the front width and two tapered side lengths, of the bottom surface of the bottom tray 126. Furthermore, a groove 1506, which is a channel to receive the tongue 1504, is formed along the three edge portions corresponding to the three edges of the tapered U-shape of the bottom shelf 106. The dimensions of the tongue 1504 and the groove 1506 should be configured so that the engagement strength between the tongue 1504 and groove 1506 allows for a user to easily attach his/her tray to the shelf by placing the tongue framed on the bottom surface of the tray to fit in the groove formed on the shelf, and also easily detach the tongue from the groove by simply lifting the tray from the shelf.

In the previous example, such as illustrated in FIGS. 1, 2 and 8, with respect to the vertical section 109 of the frame 108, the top and bottom shelves 102 and 106 are placed on one side facing toward the direction of movement of the cart 100, and the middle shelf 104 is placed on the opposite side. Thus, when viewed along the vertical direction, the overlap between the top tray's bottom surface area and the middle tray's top open area is minimal or none; the overlap between the middle tray's bottom surface area and the bottom tray's top open area is minimal or none; and the top shelf 102 and the bottom tray 126 are vertically spaced apart. Furthermore, the horizontal dimension along the direction of movement, the length, of the bottom shelf 106, hence the bottom tray 126, is the largest; the length of the middle shelf 104, hence the middle tray 124, is the smallest; and the length of the top shelf 102, hence the top tray 122, is between the largest and the smallest. The example configuration of the shelves of the cart body and the corresponding trays as above allows for easy in-situ scanning of items placed in the trays by using a handheld scanner. Variations and/or combinations of configurations of the shelves and trays are possible, as long as easy in-situ scanning of items placed in the trays by using a handheld scanner is facilitated.

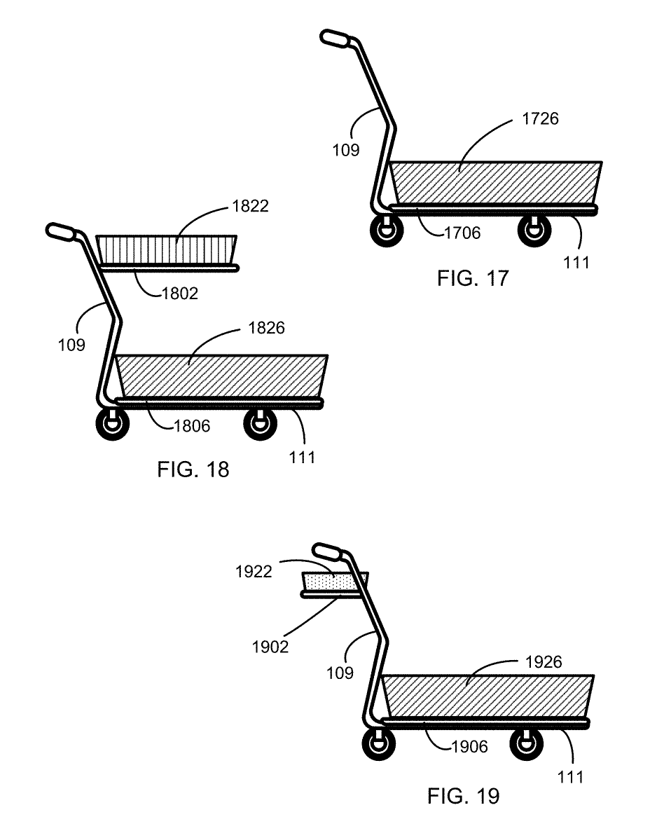

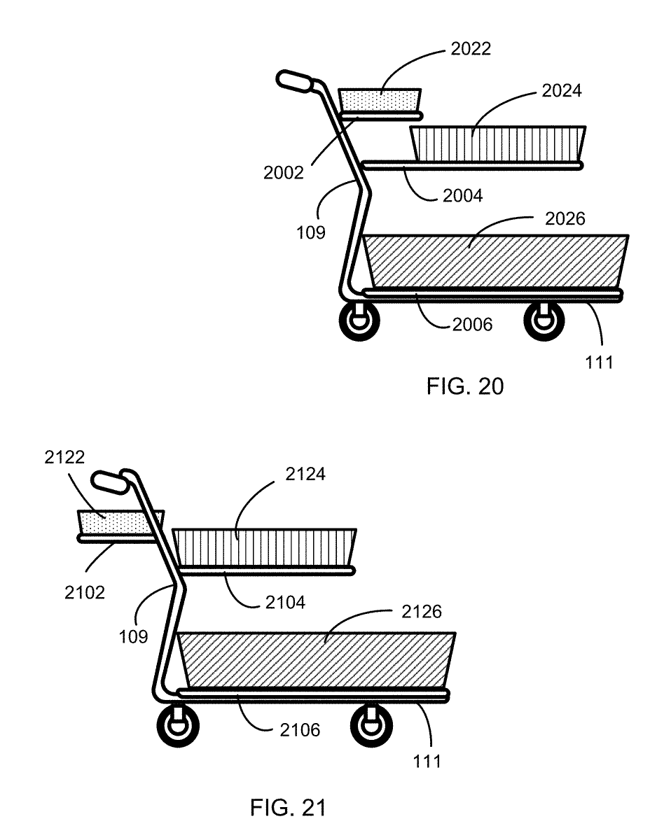

FIGS. 17-21 illustrate a side view of five example configurations of the shelves and trays, respectively, according to embodiments. FIG. 17 illustrates an example configuration, wherein the shopping cart comprises a cart body including only a bottom shelf 1706 and a. corresponding bottom tray 1726 that is configured to be attached to and detached from the bottom shelf 1706 by a user. As mentioned earlier with reference to FIG. 1, the horizontal bottom section 111 of the cart body may be configured to couple to the bottom self 1706, in that: the horizontal bottom section 111 itself may be modified or configured for use as the bottom shelf 106; alternatively, the bottom shelf 1706 may be attached or integrated with the horizontal bottom section 111; further alternatively, the bottom shelf 1706 may be positioned and mechanically held above the horizontal bottom section 111 with small vertical spacing in between. Since the space above the bottom tray 1726 is wide open in this example configuration illustrated in FIG. 17, in-situ scanning of items placed in the bottom tray 1726 by using a handheld scanner can be easily carried out FIG. 18 illustrates another example configuration, wherein the shopping cart comprises a cart body including a top shelf 1802 and a bottom shelf 1806 and corresponding top and bottom trays 1822 and 1826 that are configured to be attached to and detached from the top shelf 1802 and the bottom shelf 1806, respectively, by a user. With respect to the vertical section 109 of the cart body, these two shelves are placed on one side facing toward the direction of movement of the cart. The vertical spacing above the bottom tray 1826 and below the top shelf 1802 is configured to be sufficiently large, enabling easy in-situ scanning of items placed in each tray by using a handheld scanner. FIG. 19 illustrates yet another example configuration, wherein the shopping cart comprises a cart body including a top shelf 1902 and a bottom shelf 1906 and corresponding top and bottom trays 1922 and 1926 that are configured to be attached to and detached from the top shelf 1902 and the bottom shelf 1906, respectively, by a user. With respect to the vertical section 109 of the cart body, the bottom shelf 1906 is placed on one side facing toward the direction of movement of the cart, and the top shelf 1902 is placed on the opposite side. The overlap between the top tray's bottom surface area and the bottom tray's top open area is configured to be minimal or none, enabling easy in-situ scanning of items placed in each tray by using a handheld scanner. FIG. 20 illustrates yet another example configuration, wherein the shopping cart comprises a cart body including a top shelf 2002, a middle shelf 2004 and a bottom shelf 2006 and corresponding top, middle and bottom trays 2022, 2024 and 2026 that are configured to be attached to and detached from the top shelf 2002, the middle shelf 2004 and the bottom shelf 2006, respectively, by a user. With respect to the vertical section 109 of the cart body, all the shelves are placed on one side facing toward the direction of movement of the cart. The top shelf 2002 is positioned higher than the middle shelf 2004. When viewed along the vertical direction, the overlap between the top tray's bottom surface area and the middle tray's top open area is minimal or none, and wherein sufficiently large vertical spacing is provided above the bottom tray 2026 and below the middle shelf 2004. With this configuration of the shelves and trays, in-situ scanning of items placed in each tray by using a handheld scanner can be easily carried out. FIG. 21 illustrates yet another example configuration, wherein the shopping cart comprises a cart body including a top shelf 2102, a middle shelf 2104 and a bottom shelf 2106 and corresponding top, middle and bottom trays 2122, 2124 and 2126 that are configured to be attached to and detached from the top shelf 2102, the middle shelf 2104 and the bottom shelf 2106, respectively, by a user. With respect to the vertical section 109 of the cart body, the middle and bottom shelves 2104 and 2106 are placed on one side facing toward the direction of movement of the cart, and the top shelf 2102 is placed on the opposite side. The top shelf 2102 is positioned higher than the middle shelf 2104. When viewed along the vertical direction, the overlap between the top tray's bottom surface area and the middle tray's top open area is minimal or none. Sufficiently large vertical spacing is provided above the bottom tray 2126 and below the middle shelf 2104. With this configuration of the shelves and trays, in-situ scanning of items placed in each tray by using a handheld scanner can be easily carried out.

As illustrated in FIG. 17-21, as well in FIG. 1, the cart bodies may be configured to nest within each other in a line to facilitate collecting and also to save on storage space. The nesting distance is substantially determined by the dimensions and the shape of the one or more shelves that are placed, with respect to the vertical section 109 of the cart body, on the side facing toward the, direction of movement of the cart. For example, as illustrated in FIG. 10, the generally tapered U-shaped shelves allow for space-saving nesting of the cart bodies owing to the rear opening of the U-shaped shelves. Here, one of ordinary skill in the an would understand that the horizontal bottom section 111, which is coupled to the bottom shelf 106, should be correspondingly configured to have a rear opening.

For a user to easily hold and carry the trays, these trays may be designed to include handles, holes or other structures, as conceived by one of ordinary skill in the art. In one example, two or more handles can be installed at the two or more top edge portions, respectively, of the tray, such as those used to carry dishes in a restaurant or at home. The handles may be fixed or swivel. In another example, two or more holes can be formed on the two or mode side surfaces, respectively, close to the top opening, of the tray, such as those used to carry letter mails. The dimensions of the holes should be configured for four fingers to be easily inserted and hold the tray by grabbing hold of the portion above the hole. In yet another example, the top edge portions may be formed to bend outwardly so that fingers can hold the bent portions, such as those typically used for containing and transporting personal items and carry-on bags through an X-ray system at a security checkpoint in an airport

The trays may be configured to have corresponding lids, which can be used as the shelves of the cart body. A user may want to cover the items in the tray with the corresponding lid to keep frozen items cool after the purchase, for example. Referring back to FIG. 2, during the shopping and checkout, the lids may remain attached to the frame 108 of the cart body to be used as the shelves 102, 104 and 106, onto which the, respective trays 122, 124 and 126 are attached and held. For this purpose, the shelves, which are also the lids of the trays in this case, are configured to be attached to and detached from the frame 108. The attaching mechanism of the lids to the frame 108 of the cart body may include hooks, latches or any other conventional fastening means, as long as each lid can be positioned and held substantially horizontal even with the load arising from the items in the trays, and can be easily detached from the frame 108 by the user. Each tray and the corresponding lid can be configured to be attached to and detached front each other, as in the case of the tray and the corresponding shelf explained earlier. For example, each lid may be configured to have bent-down side sections to cover and snap on the top open section of the tray, thereby providing a basket-like shape with four raised side sections when flipped over, wherein the heights of the side sections are configured to be lower than the height of the corresponding tray so that the tray can easily fit in the basket-like shape. Alternatively or additionally, hooks, latches, bands such as the one illustrated in FIG. 13 or other fastening means can be used. The tongue-and-groove mechanism similar the one illustrated in FIGS. 14-16 may also be used with necessary modifications as per one of ordinary skill in the art.

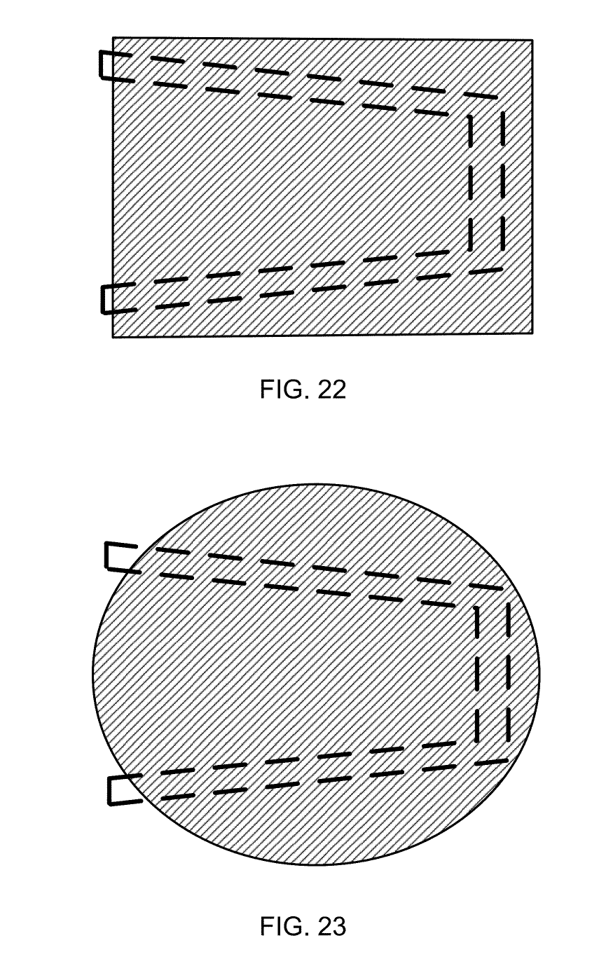

Since the nesting concerns only the cart bodies, the shapes of the trays are not limited to those with the tapered sides as illustrated in FIG. 8, when each of the shelves is configured to have a generally tapered U-shape. The trays can have any horizontal shapes, as long as, they are configured to be attached to and detached from respective shelves, to stay stably when attached, and to enable easy in-situ scanning of items therein while being attached to the respective shelves. FIGS. 22 and 23 illustrate example configurations of a shelf and a tray detachably attached thereto, wherein the overall horizontal shape of the shelf and that of the corresponding tray are substantially different. Similar to the shelf illustrated in FIG. 8, the shelf illustrated in FIGS. 22 and 23 has a generally U-shaped frame for holding the bottom of the tray, the generally U-shaped frame tapered toward the direction of movement and having an opening at the rear side with respect to the direction of movement. The trip view of the shelf is indicated by dashed line in FIGS. 22 and 23. The horizontal shape of the tray is substantially rectangular in the example configuration in FIG. 22. The horizontal shape of the tray is substantially oval in the example configuration in FIG. 23. These and other horizontal shapes can be devised for the tray, as long as it can be stably attached to and held on the shelf, the horizontal shape of which is tapered toward the direction of movement of the shopping cart for nesting purposes. One or more engagement mechanisms can be used to engage the trays and the corresponding shelves, including latches, hooks, fasteners, bands, tongue-and-grooves, etc. Additionally, stoppers may be configured at the front end of the shelf, for example, to prevent sliding of the tray.

At present, in most retail stores including supermarkets, certain items such as fruits and vegetables are sold loosely in that a shopper puts them in a plastic bag as much as he/she wants and the bag needs to be weighed at the checkout counter to register the price by multiplying the price per unit weight times the total weight. In order to facilitate the present scanning, wherein the items that the user picked up and placed in the trays remain in the trays during the scanning, each item needs to have a code to be scanned. One way to pre-code an item, which is typically sold loosely such as fruits and vegetables, is for the retailer to pre-pack the item with different weights and include the corresponding individual prices in the codes displayed on the packages, respectively. Another way is to install a device in the loose-item section of the store, wherein the device allows a shopper to weigh the bag containing the item he/she put in, and generates a sticker having the code including the price. Thereafter, the shopper places the sticker on the bag, puts the bag in the tray of the cart, and moves to the checkout counter, where the bag containing the loose item can be scanned in-situ.

One problem associated with scanning by using a handheld scanner is that the scanning person, either a worker of the store or a shopper himself/herself, may miss an item or two. In most case, this could be a human error that may not be completely avoided even the scanning person is well trained or experienced. Examples of conventional countermeasures include detection of the item that was not scanned by using a detection device installed, for example, before the exit of the store. The device may be configured to include a sensor that can detect an un-scanned code and emit an audible sound or other warning sign to stop the shopper from passing. Another conventional countermeasure is to perform a visual check of the items in the trays against the receipt that the shopper has received from the cashier at the checkout counter. The visual check may be performed by one or more workers of the store around the exit of the store.

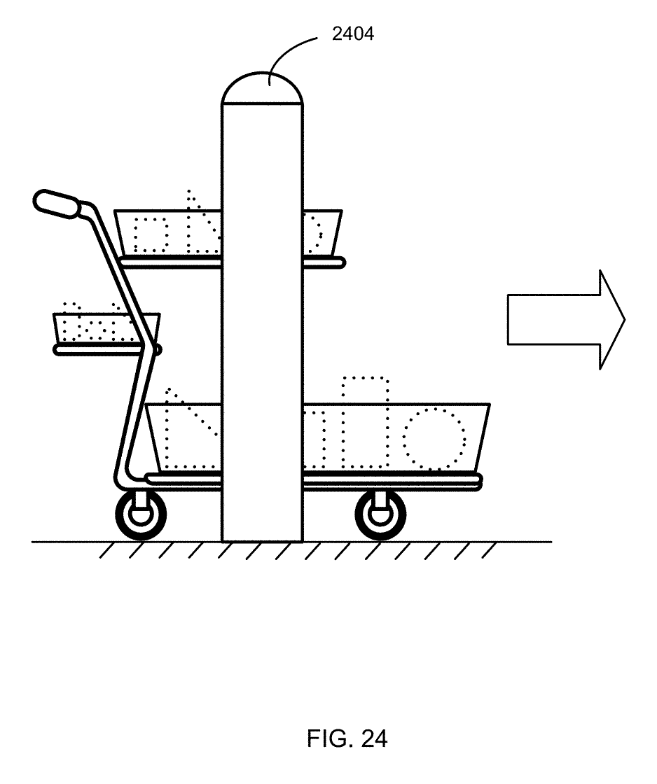

A tunnel-shaped scanner may become available even for items shopped at retail stores. Examples of currently available tunnel-shaped scanners include a scanning machine at a security checkpoint in an airport, wherein items such as personal items and carry-on luggage in trays pass under the arched or tunnel-shaped scanning machine. The items are typically oriented in various angles, and the depth for the scanning ray to reach varies from items to item. However, as the scanning technology advances, it may become possible to scan items variously oriented and variously placed or even stacked in the trays of the shopping cart. With the advent of such advanced technologies, a tunnel-shaped scanner may become possible for use at retail stores, alternative to a handheld scanner such as illustrated in FIGS. 6 and 7. FIG. 24 illustrates a side view of an example configuration of in-situ scanning of the items in the trays by using a tunnel-shaped scanner. The items the user picked up and put in the trays are indicated by dotted lines in this figure. The arrow indicates the direction of movement of the shopping cart, which may be pushed by the shopper or a worker of the store to pass through the tunnel-shaped scanner 2204. Alternatively, the whole shopping cart including the items in the trays may be transferred to a conveyer belt that runs under the tunnel-shaped scanner 2404. In either case, the one or more shelves and the one or more trays while attached thereto are configured so that the codes on the items are scanned and registered for checkout as the items pass under the scanning ray coming from the top portion and/or the side portion of the tunnel-shaped scanner 2404.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be exercised from the combination, and the claimed combination may be directed to a subcombination or a variation of a subcombination.

1. A shopping cart comprising:
a cart body comprising one or more shelves; and
one or more trays configured to be detachably attachable to the one or re shelves, respectively, and reusable,
wherein the one or more trays are configured to be owned by a user, be transported by the user to a store, be attached to the one or more shelves, respectively, by the user, be loaded with items picked up by the user in the store, go through in-sire scanning of the items therein for checkout, be detached from the one or more shelves respectively, and be transported with the purchased items therein to the user's home or a destination, wherein the in-situ scanning is done by using a scanner to scan codes on the items while they are in the one or more trays.

2. (canceled)

3. The shopping cart of claim 1, wherein
the one or more trays are made of a washable material.

4. The shopping cart of claim 1, wherein
dimensions and a shape of each of the one or more trays are configured to be stackable.

5. The shopping cart of claim 1, wherein
the one or more trays are designed to include a logo, a trademark, colors and patterns, or other visual designs indicating an image, a brand and other characteristics of a store where the one or more trays are sold.

6. (canceled)

7. The shopping cart of claim 1, wherein
the one or more shelves are configured to be one or more lids for covering the one or more trays, respectively, wherein
the one or more lids are configured to be attached to a frame of the cart body for use as the one of more shelves, respectively, during shopping and checkout, while the one or more trays are attached to the one or more shelves, respectively.

8. The shopping cart of claim 1, wherein
the one or more shelves and the one or more trays while attached to the one or more shelves, respectively, are configured to enable in-situ scanning of items by using a tunnel-shaped scanner to scan codes on the items while they are in the one or more trays, as the shopping cart with the items in the one or more trays passes under the tunnel-shaped scanner.

9. The shopping cart of claim 1, wherein
the one or more shelves and the one or more trays while attached to the one or more shelves, respectively, are configured to enable in-situ scanning of items by using a hand-held scanner to scan codes on the items while they are in the one or more trays.

10. The shopping cart of claim 9, wherein
the cart body further comprises a frame comprising a vertical section and a horizontal bottom section that is formed to be substantially horizontal to a ground, wherein the vertical section is formed to be substantially vertical to the horizontal bottom section, a top portion of the vertical section is configured to include a handle for a user to hold to steer and move the shopping cart, and the horizontal bottom section is coupled to three or more wheels, and
the one or more shelves are coupled to the frame and positioned to be substantially horizontal to the horizontal bottom section.

11. The shopping cart of claim 10, wherein
the one or more shelves comprise a first shelf coupled to the horizontal bottom section; and
the one or more trays comprise a first tray configured to be attached to and detached from the first shelf.

12. The shopping cart of claim 11, wherein
the one or more shelves further comprise a second shelf wherein, with respect to the vertical section, the first shelf and the second shelf are placed on one side facing toward a direction of movement of the shopping cart; and
the one or more trays further comprise a second nay configured to be attached to and detached from the second shelf,
wherein, while the first tray is attached to the first shelf vertical spacing above the first tray and below the second shelf, is configured to be sufficiently large to enable the in-situ scanning of items in each tray.

13. The shopping cart of claim 11, wherein
the one or more shelves further comprise a second shelf wherein, with respect to the vertical section, the first shelf is placed on one side facing toward a direction of movement of the shopping cart and the second shelf is placed on the opposite side; and
the one or more trays further comprise a second tray configured to be attached to and detached from the second shelf,
wherein, while the first and second trays are attached to the first and second shelves, respectively, when viewed along a vertical direction, an overlap between the second tray's bottom surface area and the first tray's top open area is minimal or none, enabling the in-situ scanning of items in each tray.

14. The shopping cart of claim 12, wherein,
the one or more shelves further comprise a third shelf, wherein, with respect to the vertical section, the third shelf is placed on the side facing toward the direction of movement of the shopping can and positioned higher than the second shelf; and
the one or more trays further comprise a third tray configured to be attached to and detached from the third shelf,
wherein, while the second and third trays are attached to the second and third shelves, respectively, when viewed along a vertical direction, an overlap between the second tray's top open area and the third tray's bottom surface area is minimal or none, enabling the in-situ scanning of items in each tray.

15. The shopping cart of claim 12, wherein
the one or more shelves further comprise a third shelf, wherein, with respect to the vertical section, the third shelf is placed opposite to the side facing toward the direction of movement of the shopping cart and positioned higher than the first shelf and lower than the second shelf, and
the one or more trays further comprise a third tray configured to be attached to and detached from the third shelf,
wherein, while the first, second and third trays are attached to the first, second and third shelves, respectively, when viewed along a vertical direction, an overlap between the second tray's bottom surface area and the third tray's top open area is minimal or none and an overlap between the first tray's top open area and the third tray's bottom surface area is minimal or none, enabling the ill-situ scanning of items in each tray.

16. The shopping cart of claim 13, wherein
the one or more shelves further comprise a third shelf, wherein, with respect to the vertical section, the third shelf is placed on the side facing toward the direction of movement of the shopping cart and positioned lower than the second shelf; and
the one or more trays further comprise a third tray configured to be attached to and detached from the third shelf,
wherein, while the first tray is attached to the first shelf, vertical spacing above the first tray and below the third shelf, is configured to be sufficiently large to enable the in-situ scanning of items in the first tray,
and wherein, while the second and third trays are attached to the second and third shelves, respectively, when viewed along a vertical direction, an overlap between the second tray's bottom surface area and the third surface's top open area is minimal or none, enabling the in-situ scanning of items in each tray.

17. The shopping cart of claim 1, wherein dimensions and a shape of one of the one or more trays are configured to it in a shopping basket.

18. The shopping cart of claim 10, wherein
the one or more shelves comprise at least one shelf that is placed, with respect to the vertical section, on one side facing toward a direction of movement of the shopping cart,
wherein each of the at least one shelf is configured to have a horizontal shape of a generally U-shaped frame for holding a tray, the generally U-shaped frame tapered toward the direction of movement and having an opening at a rear side with respect to the direction of movement.

19. The shopping cart of claim 18, wherein
the one or more trays comprise at least one tray that is configured to be attached to and detached from the at least one shelf, respectively, via an engagement mechanism including a tongue-and-groove mechanism.

20. A method of using a shopping cart comprising a can body comprising one or more shelves and one or more trays configured to be detachably attachable to the one or more shelves, respectively, and reusable, wherein the one or more shelves and the one or more trays, while attached respectively to each other, are configured to enable in-situ scanning of items by using a handheld scanner to scan codes on the items while they are in the one or more trays, the method comprising:
purchasing to own the one or more trays;
transporting the one or more trays to a store;
attaching the one or more trays to the one or more shelves of the cart body, respectively;
loading the one or more trays with items while picking up the items in the store;
going through the in-situ scanning of the items in the one or more trays for checkout;
detaching the one or more trays loaded with the purchased items from the one or more shelves, respectively; and
transporting the one or more trays loaded with the purchased items to a user's home or a destination.
